(19) United States
(12) Patent Application Publication
(10) Pub. No.: US 2014/0188969 A1
(43) Pub. Date: Jul. 3, 2014

(54) Efficient Algorithm to Bit Matrix Symmetry

(71) Applicant: LSI CORPORATION, Milpitas, CA (US)

(72) Inventors: Deepti P. Chotai, Pune (IN); Shankar T. More, Pune (IN)

(73) Assignee: LSI CORPORATION, Milpitas, CA (US)

(21) Appl. No.: 13/729,296

(22) Filed: Dec. 28, 2012

(51) Int. Cl. G06F 17/16

(52) U.S. Cl. CPC G06F 17/16
USPC 708/520

(57) ABSTRACT

An algorithm that maintains the symmetry of a symmetric bit matrix stored in computer memory without having to process all of the elements of a transpose column by considering only the elements changed in a row. The algorithm operates on groups of bits forming rows of the matrix rather than processing the individual bit elements of the matrix. Instead of checking whether each bit needs to be modified, the algorithm toggles only the column bits that are the transpose elements of modified row elements, thereby taking advantage of the existing symmetry to eliminate unnecessary conditional operations. As a result, the algorithm modifies the matrix on a row-by-row basis and makes changes to only those column bits that correspond to modified row elements without having to check the value of the transpose column elements that do not require modification.

### TECHNICAL FIELD

The present invention relates to data processing and storage systems for computers and, more particularly, to an efficient algorithm for maintaining symmetry of a bit matrix stored in computer memory.

### BACKGROUND

A symmetric matrix is same as its transpose. In other words, if an element in the matrix E can be represented as E[R,C] where “R” represents the row number and “C” represents the column number, then any element in a symmetric matrix E[R,C] has the same value as its transpose element E[C,R]. The element E [C,R] can therefore be referred to as the transpose element of E[R,C]. For example, element [3,4] can be referred to as the transpose element for element [4,3]. Similarly, each row having an index (row number) has a corresponding transpose column having the same index (column number). For example, the column C=3 can be referred to as the transpose column for row R=3.

In order to keep the symmetry of a symmetric matrix intact whenever a row P is modified, it is also necessary to modify the column P in the same manner such that the values of row P remain the same as the values of column P and vice-versa. A generalized algorithm for maintaining the symmetry of a symmetric bit matrix uses the following concept: for each element of a row changed (X[R,C]), also change the transpose element (X[C,R]) so that each element and its transpose remain the same. An algorithmic procedure for maintaining the symmetry of a symmetric bit matrix may be expressed as:

For each element X[R,C] in row “R” being modified;

Set X[C, R]=X[R, C]; where “N” is the total number of columns in the matrix and “C” varies from 0 to N-1 or from 1 to N.

A bit matrix is a matrix whose individual elements are single bits that hold a value of either a zero or a one. In case of bit matrices stored in computer memory, however, it is not efficient to access each individual element, as the individual bits are not directly represented using basic data types such as 1 byte, 2 byte and 4 byte words. Hence X[C,R]=X[R,C] cannot be implemented directly on a bit-by-bit basis in the case of a bit matrix stored in computer memory. In addition, the elements of a row of a matrix stored in computer memory are typically stored sequentially in memory, which means that the elements of a column are not stored sequentially. This makes it inefficient to access the individual bits in a column.

Moreover, the generalized method for maintaining matrix symmetry (i.e., set X[C,R]=X[R,C] as “C” varies from 0 to N-1) is inefficient because it requires processing all the elements of the transpose column irrespective of the number of elements to be changed in the column. No existing algorithms are capable of ensuring the symmetry of a bit-matrix when a row of the matrix is modified without processing all of the elements of the transpose column of the modified row. There is, therefore, a continuing need for more efficient algorithms for maintaining the symmetry of a symmetric bit matrix stored in computer memory. More particularly, there is a need for an algorithm that maintains the symmetry of a bit matrix stored in computer memory without having to process all of the elements of a transpose column for a modified row by considering only the elements changed in that row.

### SUMMARY

The needs described above are met in a computer implemented bit-matrix symmetry algorithm that maintains the symmetry of a symmetric bit matrix stored in computer memory without having to process all of the elements of a transpose column for a modified row by considering only the elements changed in that row. The algorithm achieves this improvement by operating on groups of bits (e.g., byte, word, dword) forming rows of the matrix rather than processing the individual bit elements of the matrix one at a time. When modifying the bits of the transpose column, instead of checking whether each bit needs to be set or cleared, the algorithm directly toggles only those column bits that are the transpose elements of modified row elements, thereby taking advantage of the existing symmetry to eliminate unnecessary conditional operations. As a result, the algorithm modifies the matrix on a row-by-row basis and makes changes to only those column bits that correspond to modified row elements without having to check the value of any column elements that do not require modification.

More specifically, the algorithm is configured to operate on a bit matrix that has a symmetric initial state and maintain the symmetry of the matrix whenever a row of the matrix is modified. The algorithm operates by creating a bitmap of changed elements for the modified row “R” indicating which elements of the row have been modified. The bitmap of changed row elements will have bits corresponding to the changed row elements as set and bits corresponding to unchanged row elements will be zero. In this bitmap, a bit having index “M” will correspond to an element A[R,M] in row R and where M can vary from 0 to N-1 or 1 to N in an N×N matrix. As the elements of a column are not stored sequentially, it is inefficient to access the individual bits in a column for maintaining symmetry. So for a changed row “R”, a “transpose column bit toggling mask” is prepared, which has a single bit set corresponding to the transpose column of the modified row “R”. This mask is used on all the rows for which column “R” bit needs to be modified for symmetry with row “R”. Then, for each bit set in the bitmap of changed row elements, the algorithm gets the index “M” of a bit set in the bitmap of changed row elements, then in row “M”, toggles the column “R” bit using ‘transpose column bit toggling mask’, and clears that bit in the changed row elements bitmap to indicate that the row element modification has been processed for the current iteration. The algorithm repeats this process until the value of the bitmap of changed elements is equal to zero indicating that all of the modified row elements have been processed by toggling the corresponding transpose element in column “R”. Once all of the transpose modifications have been entered in column “R”, the original row “R” content is overwritten with the modified row “R” content, making the matrix “A” symmetric. The row “R” should be overwritten at the end instead of before toggling the column elements, to prevent double toggling of the R^{th} bit of row R i.e. A[R,R].

In a specific embodiment of the invention, the bitmap of changed elements for a modified row “R” may be determined by:

Bitmap of Changed Elements=OldRowContents XOR NewRowContents.

The transpose column bit toggling mask “B” may be determined by:

Transpose Column Bit Toggling Mask B=In a single row matrix setting all the elements to 0 except the transpose column bit (R) to 1. This can be achieved by shifting operation.

And the transpose of a column element for any modified Mth bit of changed row R is achieved by bit toggle operation:

Row M (modified)=Row M (prior) XOR Mask B.

The row contents is overwritten at the end of the process, after the transpose column elements have been modified, so that the element[R,R] of the row being processed does not get toggled twice to hold an incorrect value. This algorithm ensures that only elements that are different from the original value in the modified row are processed in the transpose column. As a result, the algorithm offers linearly improving efficiency when complete or part of the matrix is modified row by row with symmetrical input. Because the transpose elements are toggled only for the row elements that have been modified, the time consumed by the algorithm is less if a row is only partially changed. In other words, the performance of the algorithm is adaptive to the number of bits changed in a row. It should be noted that the algorithm can be implemented in software as well as hardware.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE FIGURES

The numerous advantages of the invention may be better understood with reference to the accompanying figures in which:

FIG. 1 is an illustration of a symmetric matrix.

FIG. 2 is an illustration of matrix symmetry maintenance.

FIG. 3 is an illustration of a symmetric bit matrix.

FIG. 4 is an illustration of a symmetric bit matrix data as stored in computer memory with little-endian bit order, identifying a row R to be modified.

FIG. 5 is an illustration of new contents for the row R in the symmetric bit matrix that is shown in FIG. 4.

FIG. 6 is an illustration of the matrix after the row modification has been entered and its transpose element has also been modified to maintain symmetry of the matrix.

FIG. 7 is an illustration of the computation of a bitmap of changed elements in a row, used for maintaining symmetry of the matrix.

FIG. 8 is an illustration of a transpose column bit toggling mask used for maintaining symmetry of the matrix.

FIG. 9 is an illustration of clearing the left-most bit set in the bitmap of changed bits.

FIG. 10 is an illustration of transpose bit toggling to maintain matrix symmetry.

FIG. 11 is a logic flow diagram illustrating routine for maintaining the symmetry of a symmetric bit matrix stored in computer memory.

### DETAILED DESCRIPTION OF ILLUSTRATIVE EMBODIMENTS

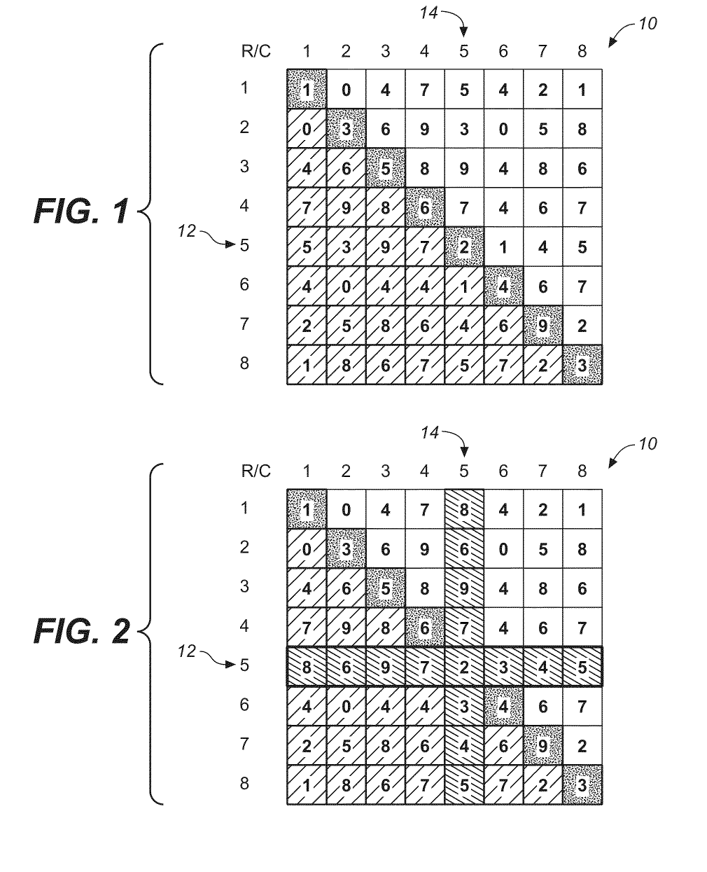

The invention may be embodied in a computer implemented bit-matrix symmetry algorithm that maintains the symmetry of a symmetric bit matrix stored in computer memory without having to process all of the elements of a transpose column for a modified row by considering only the changed elements in the row. FIG. 1 shows a symmetric matrix 10. A symmetric matrix is same as its transpose. If an element in the matrix E can be represented as E [R, C] then any element in the symmetric matrix E [R,C] is same as E [C,R]. To illustrate a symmetric matrix, FIG. 1 calls out an illustrative row 12, row 5 (R=5) which has the element values [5, 3, 9, 7, 2, 1, 4, 5]. The elements of the illustrative row 12 have the same values as the elements of the correspondingly numbered illustrative column 14, column 5 (C=5), which likewise has the element values [5, 3, 9, 7, 2, 1, 4, 5]. In particular, each element E[R,C] has the same value as its transpose element E[C,R]. For example, the first element of row E[5,1]=5 and its transpose element (the first element of column 5) E[1,5]=5. Similarly, E[5,2]=3 and E[2,5]=3; E[5,3]=9 and E[3,5]=9 and so forth. The invention provides an efficient algorithm for maintaining this type of symmetry during modification of a symmetric bit matrix stored in computer memory.

In order to keep the symmetry of the matrix intact, whenever a row P is modified in the symmetric matrix, it is also necessary to modify the column P in the matrix such that row P remains the same as column P and vice versa. This is illustrated in FIG. 2 continuing to use row 5 as an example. In FIG. 2, the values of row 5 have been changed to [8, 6, 9, 7, 2, 3, 4, 5]. In order to maintain the symmetry of the matrix, the values of the column 5 also have to be changed to [8, 6, 9, 7, 2, 3, 4, 5].

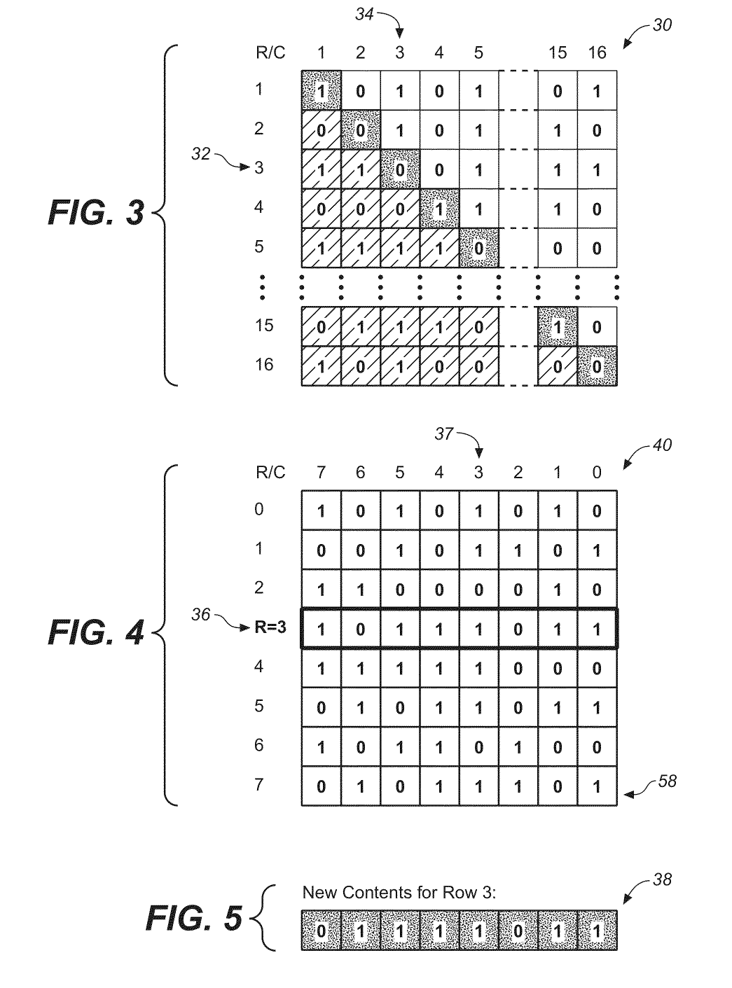

A bit matrix is a matrix whose individual elements are single bits which can hold either a zero or a one. FIG. 3 illustrates a symmetric bit matrix 30. As shown, each element of the matrix has a value of one or a zero, and each element has the same value as its transpose element. For example, E[15,1]=0 and E[1,15]=0; E[15,2]=1 and E[2,15]=1; and so forth. Similarly, each row of the matrix has the same values as is transpose column. FIG. 3 calls out an illustrative row 32, row R=3, and its transpose column 34, column C=3. The values of row 3 and column 3 are both [1, 1, 0, 0, 1 . . . 1, 1].

A generalized algorithm to keep a matrix X symmetric uses the following concept: for each element X[R,C] in row R being modified, set X[C, R] equal to X[R, C], where N is the total number of columns in the matrix and C varies from (0 to N-1) or (1 to N). In the case of bit matrices stored in computer memory, however, it is not efficient to access each element when each element is an individual bit, because individual bits are not directly represented using basic data types such as 1 byte, 2 byte and 4 byte words. Hence X[C, R]=X[R, C] cannot be used efficiently in the case of a bit matrix. In addition, the elements of a row are sequentially stored in memory whereas the elements of a column are not stored sequentially. This makes it inefficient to access the individual bits in a column. In addition, the generalized method for maintaining matrix symmetry is inefficient because it processes all the elements in the transpose column of a modified row irrespective of the number of elements changed in the row. No existing algorithms are available to ensure the symmetry of a bit-matrix when a row is modified without processing each element of the transpose column of a modified row.

The present invention provides an algorithm developed to improve the efficiency of maintaining the symmetry of a bit matrix stored in computer memory. The algorithm processes groups of bits (byte, word, dword) forming a row or part of a row of the matrix instead of processing bits forming the matrix elements individually. The algorithm also checks bits which have been modified in the matrix row and modifies only those bits in the transpose column that require modification. No processing is required for the elements of a transpose column that are not modified. As a result, when modifying the bits of the transpose column, instead of checking whether each bit needs to be set or cleared; the algorithm directly toggles only those column bits corresponding to row elements that have been modified, taking advantage of the existing symmetry to save conditional operations. The invention therefore provides an efficient algorithm for entering the modifications to the transpose column elements of a bit matrix without having to process column elements that do not require modification. The invention also allows the transpose column elements to be modified through row operations without having to locate the individual column elements for direct manipulation.

FIG. 4 is an illustration of a symmetric bit matrix 40 identifying a row 36, row R=3 to be modified. The corresponding transpose column 37, column C=3, is also called out. The initial state of the bit matrix is symmetric and the algorithm ensures maintenance of the symmetry when rows are modified. Note that the matrix 40 has an index starting with “0” (i.e., the first row is R=0 and the first column is C=0). Note also that the column numbers decrease from left to right, which is different from the matrix 30 shown in FIG. 3, in which the column numbers increment from left to right or have big-endian order. Let “R” represent the number of the row to be modified, in this example R=3. Prior to modification, the values 36 of row 3 are [1, 0, 1, 1, 1, 0, 1, 1] which are the same as the values 37 of column 3 (reading from bottom to top to correspond to the row and column numbering convention).

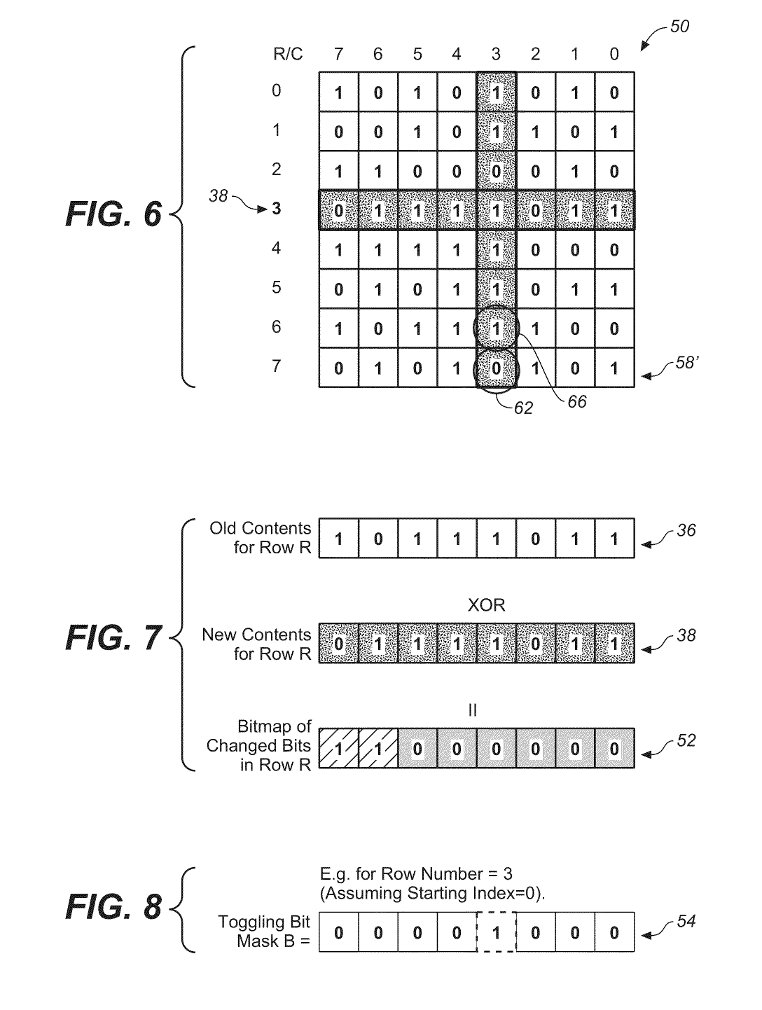

FIG. 5 shows an example of new content 38 for row R=3, which will also be entered into column C=3 by the algorithm to maintain symmetry of the matrix. FIG. 6 shows the matrix 50, which is the final result after the new content 38 has been entered into row R=3 and column C=3 of matrix 40. The procedure for modifying the matrix 40 to obtain the matrix 50 with the new content 38 entered for row R=3 and column C=3 to maintain symmetry is illustrated in FIGS. 7-10, described below.

FIG. 7 is an illustration of the computation of the bitmap of changed elements 52 used for maintaining symmetry of the matrix. The bitmap of changed elements 52 is computed by applying the logical operation “exclusive or” (XOR) to the original contents 36 for row R=3 and the modified contents 38 for row R=3:

Bitmap of Changed Elements=OldRowContents XOR NewRowContents

The result is a bitmap of changed elements 52 with values [1, 1, 0, 0, 0, 0, 0, 0], as shown in FIG. 7.

FIG. 8 illustrates the transpose column bit toggling mask 54 used for toggling the transpose column bit for maintaining symmetry of the matrix. The toggling bit mask 54 is created by left-shifting by R positions an LSB set bit [0,0,0,0,0,0,0,1] in a single row matrix having all other bits in the row as zero (note that the toggling bit mask requires R left shifts on a set bit, in this particular example because the starting index is “0” in that the first row is R=0, resulting in row R=3 occupying the fourth row in the matrix; note also that the toggling mask bit mask requires R-1 left shifts when the starting index is “1”). In this example, in which the row R=3 has been modified, left shifting a set bit [0,0,0,0,0,0,0,1] three times produces the toggling mask 52 with the values [0,0,0,0,1,0,0,0] having the set bit in the position of the column C=3, which corresponds to the transpose column that needs to be modified to maintain symmetry of the matrix.

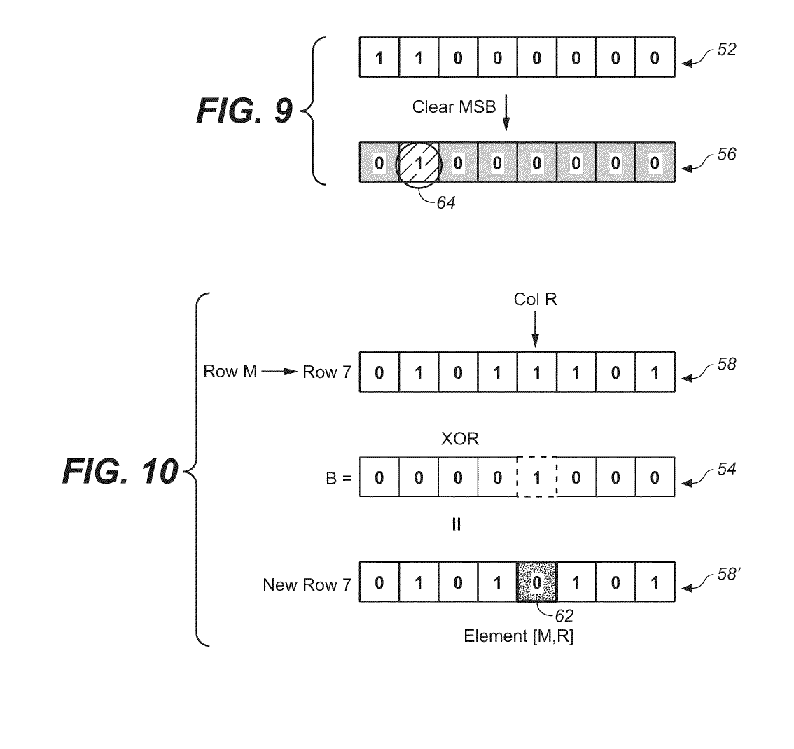

FIG. 9 is an illustration of adjustment of the bitmap of changed bits 52 for an iteration of transpose column element toggling, which produces an adjusted bitmap of changed bits 56 for the iteration by clearing the left-most bit set “M” in the bitmap of changed bits 52. That is, the original bitmap of changed bits 52 has the values [1, 1, 0, 0, 0, 0, 0, 0] and the adjusted bitmap of changed bits 56 has the values [0, 1, 0, 0, 0, 0, 0, 0] created by toggling/clearing the left-most bit set (position 7) in the bitmap 52 from a 1 to a 0.

FIG. 10 is an illustration of the adjustment to the transpose column C=3 for the first iteration. The computation for adjusting the transpose column is

Row M XOR Toggling Mask B

As the position M of the left-most bit cleared in the bitmap 52 was “7”, so the adjustment to the transpose column C=3 is computed as:

Row 7 (item 58) XOR Toggling Mask B (item 54)=Adjusted Row 7 ((item 58′).

As shown in FIG. 10, this operation toggles the bit in column R of row M, which may also be referred to as element [M,R]. The togged bit 62 for this (the first) iteration is located in position [7,3], which is identified in FIG. 10 and also called out in FIG. 6 for reference.

The procedure described above is then repeated until all of the bits in the bitmap of changed bits 52 have been cleared (i.e., until all of the changed bits in the modified row have had their corresponding transpose column elements toggled). For the specific example shown in FIGS. 7-10, the second iteration for M=6, R=3 corresponds to the M=6 bit 64 shown in FIG. 9, which results in toggling of the bit in position [6,3] identified as element 66 in FIG. 6. As M=6 is the final bit set in the bitmap of changed bits 52 for this particular example, the second iteration is followed by final step, which is to overwrite the new contents 38 for row R=3 over the original contents 36 as reflected in the final result shown in FIG. 6. The row contents is overwritten at the end of the process, after all of the transpose column elements requiring modification have been modified, so that the element[R,R] of the row R being processed (here element [3,3]) does not get toggled twice to hold an incorrect value.

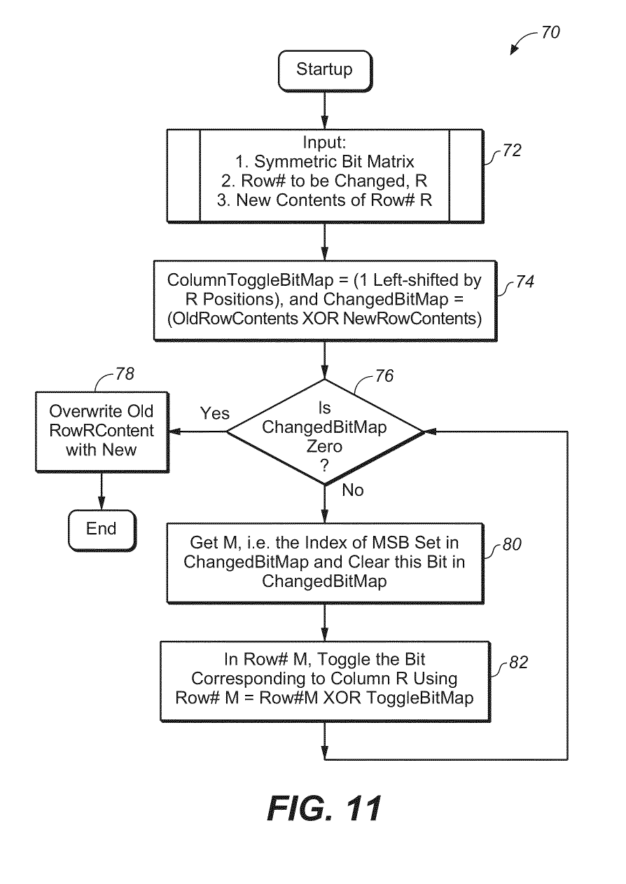

FIG. 11 is a logic flow diagram illustrating routine 70 for maintaining the symmetry of a symmetric bit matrix with a starting index of 0 (i.e., the first row is R=0 and the first column is C=0) when a row is modified. It applies to symmetric bit matrix for which column numbers increment from right to left or order of bits in a row is little-endian. Step 72 represents the starting condition, which is a symmetric bit matrix with row R to be changed from “Row R Old Contents” to “Row R New Contents.” Step 72 is followed by step 74, in which a “Toggling Bit Mask” is created by left shifting a set bit (value 1) in a single row matrix by R positions. Note that if the matrix had a starting index of 0 (i.e., the first row is R=0 and the first column is C=0) then the “Toggling Bit Mask” would be created by left shifting a set bit by R positions. In addition, a “Bitmap of Changed Bits” is computed as “Row R Old Contents” XOR “Row R New Contents.” Step 72 is followed by step 74, in which it is determined whether the contents of the “Bitmap of Changed Bits” is equal to zero (i.e., all of the bits have been cleared indicating that all of the required changes have been made to the transpose column of the modified row). If the content of the “Bitmap of Changed Bits” is equal to zero, the “Yes” branch is followed to step 78, in which the “Row R New Contents” are written to row R and the procedure is complete.

If, on the other hand, the contents of the “Bitmap of Changed Bits” is not equal to zero, the “No” branch is followed from step 76 to step 80, in which the left-most bit set M in the “Bitmap of Changed Bits” is cleared. Step 80 is followed by step 82, in which transpose bit corresponding to the cleared bit is toggled through the operation “Row M” XOR “Toggling Bit Mask.” After step 82, routine 70 loops back to step to 76 to determine whether the final required transpose element modification has been entered. If the last transpose element modification has not been entered, the steps 80 and 82 are performed for the next transpose bit requiring modification (i.e., for the next left-most bit that is set in the “Bitmap of Changed Bits”), and the process repeats until all of the bits modified in row R have had their corresponding transpose elements toggled.

The above procedure assumes matrix row and column index starting from zero and for a matrix stored in computer memory the format of data is assumed to be little-endian. The algorithm will also be applicable for matrix row and column index starting from 1 by adjusting the number of shift operations such that the desired column bit is set. For matrix stored in computer memory in big-endian format the shift operation to prepare the transpose column bit toggling mask will involve right shift on single row matrix with only MSB bit set.

The above description uses transpose column bit toggling mask of size equal to the row width but for better efficiency in large matrices the size of this mask can be less than the size of the row. To make the transpose column bit toggling operation more efficient, a subset of transpose column bit toggling mask (such that it contains the desired transpose column bit) can be used to operate on corresponding subset in a row, so as to avoid the unnecessary XOR operation on remaining bits in that row. This would lead to greater efficiency in case of larger bit matrices in which a single row is stored using multiple bytes or dwords and the mask can be a single byte or single dword operating on a single byte or single dword at desired offset in the row.

The invention claimed is:

1. A method for maintaining symmetry of a symmetric bit matrix stored in computer memory when entering changes to a row R of the matrix having an original row R contents and a modified row R contents reflecting modified bits to be entered into row R, comprising the steps of:
(a) determining a bitmap of changed bits corresponding to the modified bits to be entered into row R of the matrix;
(b) determining a transpose column bit toggling mask denoting to the transpose column of row R;
(c) toggling a transpose column element corresponding to a bit set in the bitmap of changed bits;
(d) clearing the corresponding bit set in the bitmap of changed bits for which transpose element has been toggled;
(e) determining whether the bitmap of changed bits has reached a zero value after the bit has been cleared; and
(f) in response to determining that the bitmap of changed bits has reached a zero value, overwriting the original row R contents with the modified row R contents.

2. The method of claim 1, further comprising the step of, in response to determining that the bitmap of changed bits does not have a zero value, repeating steps (c), (d) and (e) until the bitmap of changed bits has a zero value. After the bitmap reaches a zero value, execute step (f).

3. The method of claim 1, wherein the step of determining the bitmap of changed bits further comprises the step of computing an bit-wise exclusive OR operation (XOR) of the original row R contents and the modified row R contents.

4. The method of claim 1, wherein the matrix comprises a starting index of 1, having column numbers increasing from right to left in little-endian order and the step of determining the transpose column bit toggling mask further comprises the step of “left” shifting a set bit R-1 positions where R is the Row number to be modified in the matrix.

5. The method of claim 1, wherein the matrix comprises a starting index of 0, having column numbers increasing from right to left or in little-endian order and the step of determining the transpose column bit toggling mask further comprises the step of left shifting a set bit R positions where R is the Row number to be modified in the matrix. Thus, the transpose column bit toggling mask comprises of a row of bits with 0 to N-1 bits, having only the R^{th} bit corresponding to the transpose column bit as set and rest all bits as zero.

6. The method of claim 1, wherein a bit set in the bitmap of changed bits occupies position M, the matrix comprises a row M with original contents, and the step of toggling the transpose column element corresponding to the changed bit M comprises the step of computing an bit-wise Exclusive OR operation (XOR) of the original contents of row M and the transpose column bit toggling mask.

7. The method of claim 1, wherein the matrix comprises row bits stored in the computer memory in sequential order and column bits that are not stored in the computer memory in sequential order.

8. A non-transitory computer storage medium storing computer-executable instructions for maintaining symmetry of a symmetric bit matrix stored in computer memory when entering changes to a row R of the matrix having an original row R contents and a modified row R contents reflecting modified bits to be entered into row R, comprising the steps of:
(a) determining a bitmap of changed bits corresponding to the modified bits to be entered into row R of the matrix;
(b) determining a transpose column bit toggling mask denoting to the transpose column of row R;
(c) toggling a transpose element corresponding to a bit set in the bitmap of changed bits;
(d) clearing the corresponding bit set in the bitmap of changed bits for which transpose has been toggled;
(e) determining whether the bitmap of changed bits has reached a zero value; and
(f) in response to determining that the bitmap of changed bits has reached a zero value, overwriting the original row R contents with the modified row R contents.

9. The computer storage medium of claim 8, wherein the instructions further comprise the step of, in response to determining that the bitmap of changed bits with one of its bit cleared has not reached a zero value, repeating steps (c), (d) and (e) until the bitmap of changed bits has a zero value. After the bitmap reaches a zero value, execute step (f).

10. The computer storage medium of claim 8, wherein the instructions further comprise the step of determining the bitmap of changed bits further comprises the step of computing an exclusive or logical operation (XOR) of the original row R contents and the modified row R contents.

11. The computer storage medium of claim 8, wherein the matrix comprises a starting index of 1, having column numbers increasing from right to left or in little-endian order, the instructions further comprise the step of determining the transpose column bit toggling mask further comprises the step of left shifting a set bit, R-1 positions in a single row matrix where R is the Row number to be modified.

12. The computer storage medium of claim 8, wherein the matrix comprises a starting index of 0, having column numbers increasing from right to left or in little-endian order, and the step of determining the transpose column bit toggling mask further comprises the step of left shifting a set bit R positions where R is the Row number to be modified. Thus, the transpose column bit toggling mask comprises of a row of bits with 0 to N-1 bits, having only the R^{th} bit corresponding to the transpose column as set and rest all bits as zero.

13. The computer storage medium of claim 8, wherein a bit set in the bitmap of changed bits occupies position M, the matrix comprises a row M with original contents, and the step of toggling the transpose element corresponding to the bit M in the bitmap comprises the step of computing a bitwise Exclusive OR operation (XOR) of the original contents of row M and the transpose column bit toggling mask.

14. The computer storage medium of claim 8, wherein the matrix comprises row bits stored in the computer memory in sequential order and column bits that are not stored in the computer memory in sequential order.

15. A method for maintaining symmetry of a symmetric bit matrix stored in computer memory when entering changes to a row R of the matrix having an original row R contents and a modified row R contents reflecting a number X of modified bits to be entered into row R, comprising the steps of:
(a) determining a bitmap of changed bits corresponding to the modified bits to be entered into row R of the matrix;
(b) determining a toggling bit mask denoting to the transpose column of row R;
(c) performing X times (i) toggling a transpose element corresponding to a set bit M in the bitmap of changed bits, and (ii) clearing the bit M in the bitmap of changed bits; and
(d) overwriting the original row R contents with the modified row R contents.

16. The method of claim 15, wherein the step of determining the bitmap of changed bits further comprises the step of computing a bitwise Exclusive OR operation (XOR) of the original row R contents and the modified row R contents.

17. The method of claim 15, wherein the matrix comprises a starting index of 1, having column numbers increasing from right to left or in little-endian order and the step of determining the transpose column bit toggling mask further comprises the step of left shifting a set bit R-1 positions in a single row matrix , where R is the Row number to be modified.

18. The method of claim 15, wherein the matrix comprises a starting index of 0, having column numbers increasing from right to left or in little-endian order and the step of determining the toggling bit mask further comprises the step of left shifting a set bit R positions in a single row matrix, where R is the Row number to be modified. Thus, the transpose column bit toggling mask comprises of a row of bits, having only the R^{th} bit corresponding to the transpose column as set and rest all bits as zero.

19. The method of claim 15, wherein a bit in the bitmap of changed bits occupies position M, the matrix comprises a row M with original contents, and the step of toggling the transpose element corresponding to the changed bit M comprises the step of computing a bitwise Exclusive OR operation (XOR) of the original contents of row M and the transpose column bit mask.

20. The method of claim 15, wherein the matrix comprises row bits stored in the computer memory in sequential order and column bits that are not stored in the computer memory in sequential order.

21. A non-transitory computer storage medium storing computer-executable instructions for maintaining symmetry of a symmetric bit matrix stored in computer memory when entering changes to a row R of the matrix having an original row R contents and a modified row R contents reflecting a number X of modified bits to be entered into row R, comprising the steps of:
(a) determining a bitmap of changed bits corresponding to the modified bits to be entered into row R of the matrix;
(b) determining a toggling bit mask denoting to the transpose column of row R;
(c) performing X times (i) toggling a transpose column element corresponding to a set bit M in the bitmap of changed bits, and (ii) clearing the bit M in the bitmap of changed bits; and
(d) overwriting the original row R contents with the modified row R contents.

22. The computer storage medium of claim 21, wherein the step of determining the bitmap of changed bits further comprises the step of computing an exclusive or logical operation (XOR) of the original row R contents and the modified row R contents.

23. The computer storage medium of claim 21, wherein the matrix comprises a starting index of 1, column numbers incrementing from right to left or in little endian order and the step of determining the toggling bit mask further comprises the step of left shifting a set bit R-1 positions in a zero row matrix corresponding to the original row R contents.

24. The computer storage medium of claim 21, wherein the matrix comprises a starting index of 0, column numbers incrementing from right to left or little endian order and the step of determining the toggling bit mask further comprises the step of left shifting a set bit R positions in a zero row matrix corresponding to the original row R contents. Thus, the transpose column bit toggling mask comprises of a row of bits with 0 to N-1 bits, having only the R^{th} bit corresponding to the transpose column as set and rest all bits as zero.

25. The computer storage medium of claim 21, wherein the set bit in the bitmap of changed bits occupies position M, the matrix comprises a row M with original contents, and the step of toggling the transpose element corresponding to the bit M comprises the step of computing a bitwise Exclusive OR operation (XOR) of the original contents of row M and the toggling bit mask.

26. The computer storage medium of claim 21, wherein the matrix comprises row bits stored in the computer memory in sequential order and column bits that are not stored in the computer memory in sequential order.

27. A method for maintaining symmetry of a symmetric bit matrix stored in computer memory when entering changes to a row R of the matrix having an original row R contents and a modified row R contents reflecting a number X of modified bits to be entered into row R, comprising the steps of:
(a) determining a bitmap of changed bits corresponding to the modified bits to be entered into row R of the matrix;
(b) determining a toggling bit mask denoting to the transpose column of row R;
(c) performing X times (i) toggling a transpose element corresponding to a set bit M in the bitmap of changed bits, and (ii) clearing the bit M in the bitmap of changed bits; and
(d) overwriting the original row R contents with the modified row R contents.

28. The method of claim 27, wherein the step of determining the bitmap of changed bits further comprises the step of computing a bitwise Exclusive OR operation (XOR) of the original row R contents and the modified row R contents.

29. The method of claim 27, wherein a bit set in the bitmap of changed bits occupies position M, the matrix comprises a row M with original contents, and the step of toggling the transpose element corresponding to the changed bit M comprises the step of toggling the R^{th} bit in Row M.

30. The method of claim 27, wherein the matrix comprises row bits stored in the computer memory in sequential order and column bits that are not stored in the computer memory in sequential order.
